(19) United States
(12) Patent Application Publication
(10) Pub. No.: US 2008/0223528 A1
(43) Pub. Date: Sep. 18, 2008

(54) Disk labeling structure

(76) Inventor: Shu-Chi Hong, Taipei City (TW)

Correspondence Address: Joe McKinney Muncy, PO Box 1364, Fairfax, VA, 22038-1364, US

(21) Appl. No.: 11/723,113

(22) Filed: Mar. 16, 2007

(51) Int. Cl. B29C 65/00

(52) U.S. Cl. 156/581

(57) ABSTRACT

A disk labeling structure for dividing and labeling plural disks, which are strung up by a pillar, includes a fixing portion for mounting on the pillar, a labeling portion, and an extending portion for connecting the fixing portion and the labeling portion, wherein the fixing portion has a gap outwardly extended from the center thereof for accommodating the pillar, the fixing portion and the extending portion are formed to locate on a same plane and the labeling portion is perpendicular to the plane, and the direction of the gap is not parallel to the direction from the center of the fixing portion to the labeling portion.

### FIELD OF THE INVENTION

The present invention is related to a disk labeling structure, and more particularly to a disk labeling structure which is not coming off easily.

### BACKGROUND OF THE INVENTION

In the market, compact disk, such as CD, VCD and DVD, is usually used for storing a great quantity of information owing to the small volume, convenient mobility and low cost thereof. Currently, there are several methods for accommodating the disk, which are mono-piece accommodation and multi-pieces accommodation. The mono-piece accommodation may utilize a hard case, a plastic sleeve with cotton protection or a paper sleeve, and the multi-pieces accommodation is always achieved by collecting plural mono-piece sleeves in a collection case. However, the collection case must cooperate with mono-piece sleeves which might reduce the accommodation space and also increase the unnecessary weight. Now, a disk container (so called caddy), as shown in FIG. 1, is used. The disk container includes an upper cover 1 and a lower base 2, wherein plural corresponding engaging components 3, 3′ are respectively mounted on the upper cover 1 and the lower base 2, and the lower base 2 has a pillar 4 mounted at the center thereof for penetrating the central holes 6 of the disk 5. Because the disk container does not need to cooperate with other structure for accommodating a great amount of disks 5, the space can have an adequate utilization. However, if there is the need to take out a required disk 5 from the stacked ones, it has to view the mark labeled on the disk 5 piece by piece which is really inconvenient. Conventionally, a disk label is used for classifying and dividing the disks 5 in the container, as shown in FIG. 1. The disk label has a disk main body 7, an opening 8 extended from the center thereof to the edge for receiving the pillar 4 in the container, and a labeling portion 9, which is integrally formed with the main body 7, located at the edge of the main body 7 for placing the classification mark. The disks in different classifications can be separated by the disk label, so that the required disk can be easily taken out according to the mark on the labeling portion 9. However, since the labeling portion 9 is integrally formed with the main body 7 in the same plane, the upper cover 1 might not be engaged with the lower base 2 if the internal diameter of the upper cover 1 is not big enough. If container can not be covered by the upper cover 1, the disk label might be easily coming off the pillar 4 owing to shaking or tilting.

### SUMMARY OF THE INVENTION

Therefore, the object of the present invention is to provide a disk labeling structure for facilitating the division and labeling of the stacked disks, ensuring the engagement between the upper cover and the lower base of the disk container, and avoiding from coming off during shaking or tilting.

For achieving the present invention provides a disk labeling structure for dividing and labeling plural disks, which are strung up by a pillar. The disk labeling structure includes a fixing portion for mounting on the pillar, a labeling portion for placing mark thereon so as to facilitate classification, and an extending portion for connecting the fixing portion and the labeling portion. The fixing portion, the labeling portion and the extending portion are integrally formed, the fixing portion and the extending portion are formed to locate on the same plane, and the labeling portion is perpendicular to the plane by connecting with the extending portion in a L shape, or a T shape. The fixing portion has a gap outwardly extended from the center thereof for accommodating the pillar, and the angle between the direction of the gap and the direction from the center of the fixing portion to the labeling portion is less than 90°. Therefore, as requiring taking out the disk labeling structure hooked on the pillar, it has to move backward the labeling structure along the gap, so that the disk labeling structure will not come off easily. Besides, the fixing portion has a first protrusion ring or indent ring mounted thereon and located at a position contacting a circular protrusion on the disk, and the diameter of the first protrusion ring or indent ring is identical to that of the circular protrusion. The fixing portion, at the opposite side, has a second protrusion ring at a position corresponding to the first protrusion ring or indent ring. The installation of the protrusion ring or indent ring can increase the division space between the disks or slightly immobilize the disk contacted therewith.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing the appearance of a disk container with a disk label in the prior art;

FIG. 2 is a schematic view showing the appearance of a disk labeling structure according to the present invention;

FIG. 3 is a schematic view showing the appearance of a disk labeling structure in a second embodiment according to the present invention;

FIG. 4 is a schematic view showing the usage of a disk labeling structure according to the present invention;

FIG. 5 is a sectional drawing showing the 5-5 section of a disk labeling structure in a second embodiment according to the present invention; and

FIG. 6 is a sectional drawing showing the 5-5 section of a disk labeling structure in a third embodiment according to the present invention.

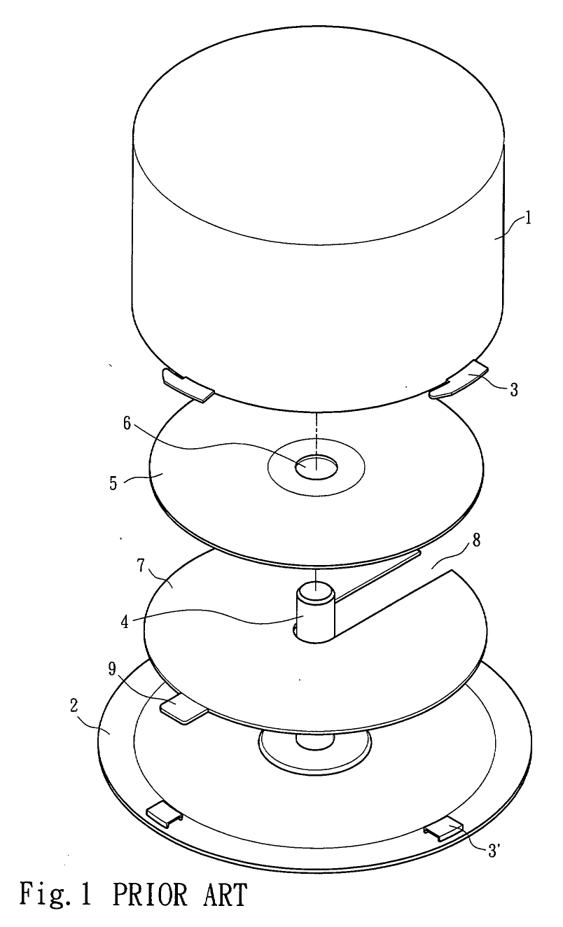

### DESCRIPTION OF THE PREFERRED EMBODIMENT

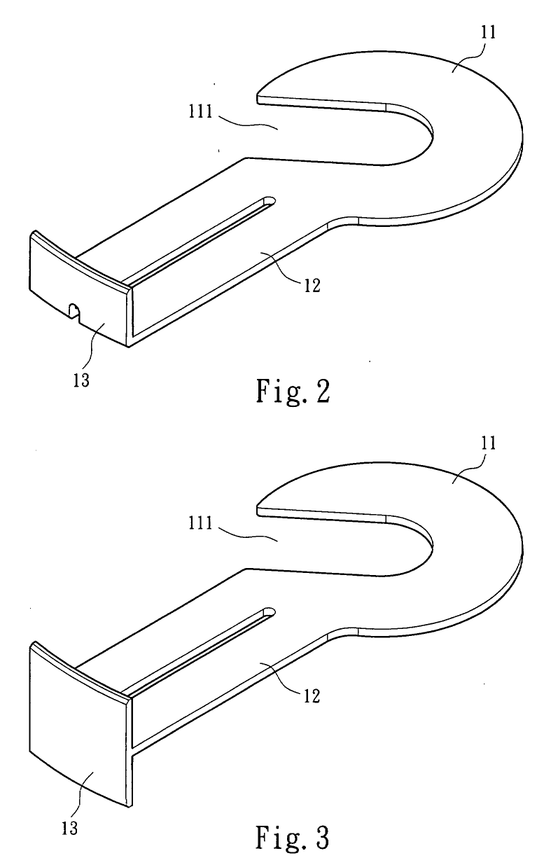

Please refer to FIG. 2 and FIG. 3, which are respectively the schematic views showing the appearances of different embodiments according to the present invention. The disk labeling structure according to the present invention is used to separate and label plural disks (not shown), which are enclosed by a disk container (not shown). The disk labeling structure includes a fixing portion 11 for locating on the disk container, a labeling portion 13 which is formed as a flat surface for placing the mark, and between the fixing portion 11 and the labeling portion 13, an extending portion 12 for connection, wherein the fixing portion 11, the extending portion 12 and the labeling portion 13 are integrally formed. The fixing portion 11 has a gap 111, which is outwardly extended from the center thereof and is used to fix with the disk container, and the length from the center to the inner edge of the labeling portion 13 should be at least larger than the radius of the disk, more exactly, the inner edge of the labeling portion 13 should be just rejected at the outer edge of the disk. Furthermore, the fixing portion 11 and the extending portion 12 are formed to locate on the same plane and the labeling portion 13 is perpendicular to the plane. Here, the labeling portion 13 and the extending portion 12 can be connected in the way that they are in a L shape (as shown in FIG. 2), or a T shape (as shown in FIG. 3).

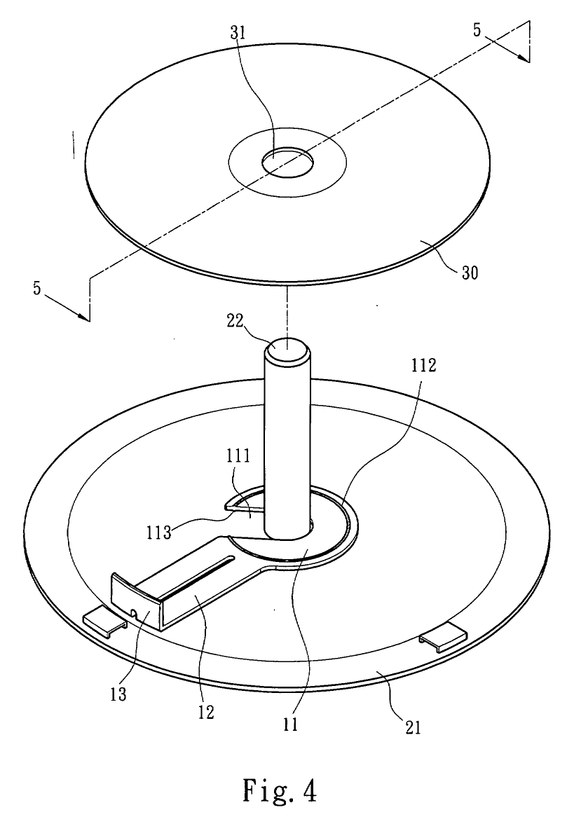

Please refer to FIG. 4, which is a schematic view showing the usage of the disk labeling structure according to the present invention which is cooperated with the disk container. The disk container includes a base 21 and a cover (not shown), wherein the base 21 has a pillar 22 upwardly extended from the center thereof for penetrating the hole 31 of the disk 30 so as to string up plural disks 30. The fixing portion 11 of the disk labeling structure can hook the pillar 22 through the gap 111 since the direction of the gap 111 is not parallel to the direction from the center of the fixing portion to the labeling portion 13, and further, the included angle between the two directions is lees than 90°. And, since the fixing portion 11 of the disk labeling structure has a hook shape, for removing, the disk labeling structure has to be moved along the direction of the gap 111, so that, as comparing to the prior art, the disk labeling structure according to the present invention truly can avoid the situation of easily coming off the disk container if the disk container is shaken or tilted which may lose the classification of the disks 30.

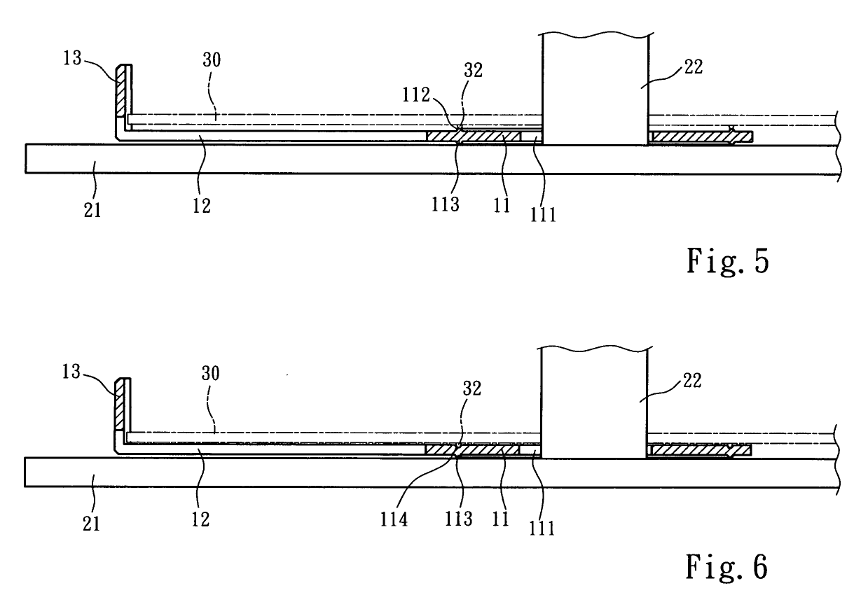

FIG. 5 shows the 5-5 section of FIG. 4. As shown, generally, the disk 30 has a circular protrusion 32 located the back side thereof, and at the corresponding position, the fixing portion 11 of the disk labeling structure according to the present invention has mounted a first protrusion ring 112 for contacting the circular protrusion 32, and at the opposite side of the fixing portion 11, a second protrusion ring 113 is also mounted at the position corresponding to the first protrusion ring 112. Here, alternatively, the first protrusion ring 112 also can be replaced by an indent ring 114, as shown in FIG. 6, whose diameter is identical to that of the circular protrusion 32. Through the first and the second protrusion rings 112, 113 mounted at both sides of the fixing portion 11, a space between the disk 30 and the disk labeling structure can be produced for facilitating the division and also avoiding the scrape on the disk surface. As the other situation of the fixing portion 11 having the second protrusion ring 113 and the indent ring 114 at the both sides, the indent ring 114 can be engaged with the circular protrusion 32 so as to slightly immobilize the disk labeling structure with the upper disk 30.

In the aforesaid, the disk labeling structure according to the present invention utilizes a gap 111 on the fixing portion 11 thereof to hook the pillar 22 in the disk container for being inserted into the stacked disks 30, and the labeling portion 13 can place the mark for classifying. Since the included angle between the direction of the gap 111 of the fixing portion 11 and the direction of the extended portion 12 is less than 90°, as the disk container shakes or tilts, the disk labeling structure might not come off the pillar to lose the classification of the stacked disks 30.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A disk labeling structure for dividing and labeling plural disks, which are strung up by a pillar, comprising:
a fixing portion for mounting on the pillar, a labeling portion, and an extending portion for connecting the fixing portion and the labeling portion, wherein the fixing portion has a gap outwardly extended from the center thereof for accommodating the pillar, the fixing portion and the extending portion are formed to locate on a same plane and the labeling portion is perpendicular to the plane, and the direction of the gap is not parallel to the direction from the center of the fixing portion to the labeling portion.

2. The disk labeling structure as claimed in claim 1, wherein the fixing portion has a first protrusion ring mounted thereon and located at a position contacting a circular protrusion on the disk, and the diameter of the first protrusion ring is identical to that of the circular protrusion.

3. The disk labeling structure as claimed in claim 2, wherein the fixing portion, at the opposite side, has a second protrusion ring at a position corresponding to the first protrusion ring.

4. The disk labeling structure as claimed in claim 1, wherein the fixing portion has an indent ring mounted thereon and located at a position contacting a circular protrusion on the disk, and the diameter of the indent ring is identical to that of the circular protrusion.

5. The disk labeling structure as claimed in claim 4, wherein the fixing portion, at the opposite side, has a second protrusion ring at a position corresponding to the indent ring.

6. The disk labeling structure as claimed in claim 1, wherein the angle between the direction of the gap and the direction of the extending portion is less than 90°.

7. The disk labeling structure as claimed in claim 1, wherein the fixing portion, the labeling portion and the extending portion are integrally formed.

8. The disk labeling structure as claimed in claim 1, wherein the length from the center of the fixing portion to the labeling portion is at least larger than the radius of the disk.

9. The disk labeling structure as claimed in claim 1, wherein the labeling portion and the extending portion are connected in an L shape.

10. The disk labeling structure as claimed in claim 1, wherein the labeling portion and the extending portion are connected in a T shape.
